(19) United States
(12) Patent Application Publication
(10) Pub. No.: US 2005/0037217 A1
(43) Pub. Date: Feb. 17, 2005

(54) Translucent barrier static shielding film

(76) Inventors: Gila Levin, Kibbutz Hanita (IL); Dany Eisenstadt, Kefar Veradim (IL); Svetlans Mosheev, Nahariya (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/500,740

(22) PCT Filed:
(86) PCT No.: PCT/IL03/00021

Related U.S. Application Data
(60) Provisional application No. 60/344,823, filed on Jan. 7, 2002.

(51) Int. Cl. B32B 27/06

(52) U.S. Cl. 428/480; 427/561; 428/336

(57) ABSTRACT

The present invention provides a composite film comprising a substrate, the substrate has a layer of a non-stoichiometric metal oxide. The present invention further provides a method for producing a composite film comprising depositing a layer of a non-stoichiometric metal oxide on a substrate. The present invention further provides a material comprising the composite film.

### FIELD OF THE INVENTION

The present invention relates to composite films, and more particularly to metal-based composite films for use in shielding bags.

### BACKGROUND OF THE INVENTION

The use of composite films comprising aluminum deposited on substrates to provide a suitable barrier to oxygen and/or water vapor is well known. The deposition of visible light-transmitting metal oxides or non-metal oxides with suitable barriers onto substrates is more difficult. EP Patent 437,946 to Kelly et al describes the use of composite films comprising metal oxide as a packaging substrate characterized by improved oxygen and/or moisture permeability. The production of a transparent metal oxide coating on the substrate that is conducted via the reactive evaporation of the metal in the presence of oxygen, or an oxygen containing gas or vapor, in stoichiometric proportions is described in British Patent Application 2210826A to Kelly et al. In U.S. Pat. No. 5,900,271, a method for a vapor-position of aluminum coating for receiving an optical adsorbing aluminum layer is described.

The moisture vapor transmission rate (MVTR) of such films is an important parameter determining the water barrier properties of the film. This parameter is usually not less than 0.05 [gr/100sqin/day] for metal-containing films. Thus, a film having an improved MVTR rate may be developed.

Embodiments of the present invention allow combining of both features semi-transparent shielding with high barrier properties.

### SUMMARY OF THE INVENTION

In one embodiment, the present invention provides a composite film comprising a substrate layer coated on one side with a layer of a non-stoichiometric metal oxide. In one embodiment, the present invention further provides a method for producing a composite film comprising depositing a layer of a non-stoichiometric metal oxide on a substrate layer.

In another embodiment, the present invention provides material comprising the composite film of the invention.

In another embodiment the invention provides use of the composite film for wrapping an object.

### BRIEF DESCRIPTION OF THE DRAWINGS

The present invention will be understood and appreciated more fully from the following detailed description taken in conjunction with the appended drawings in which:

FIG. 1 demonstrates an example of a composite film.

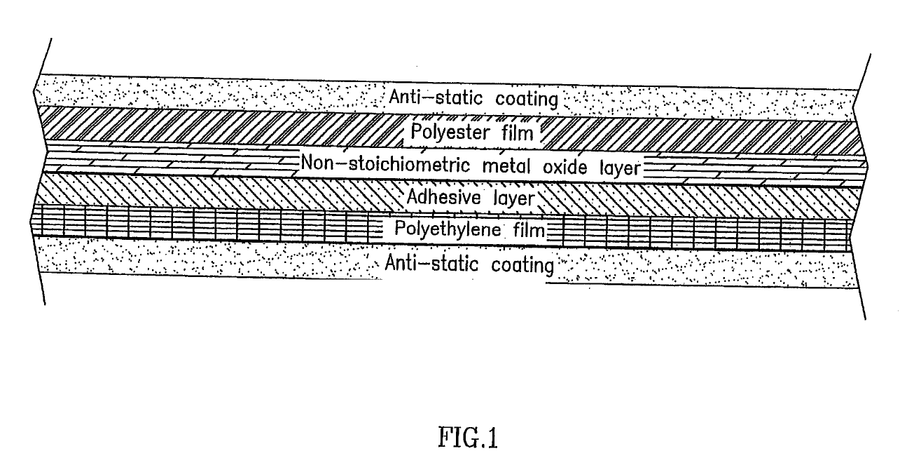

FIG. 2 demonstrates an example of a composite film.

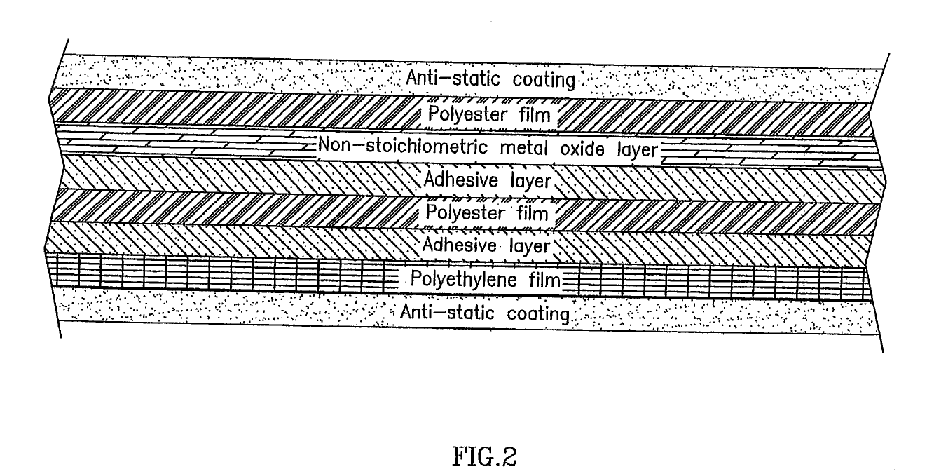

FIG. 3 demonstrates an example of a composite film.

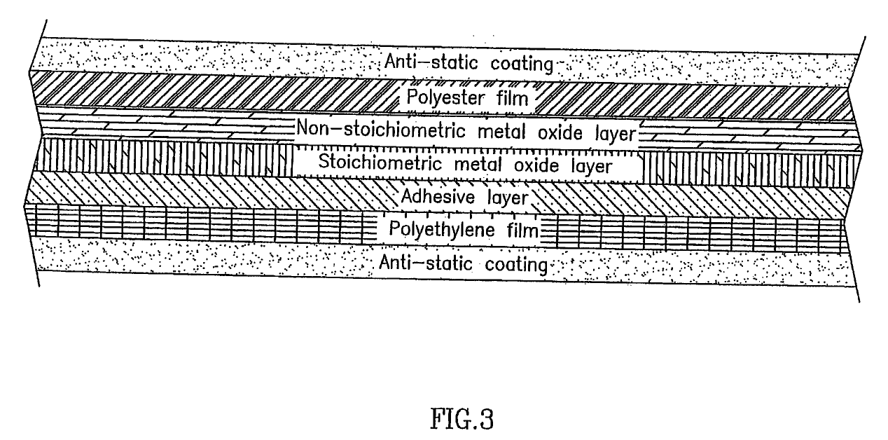

FIG. 4 demonstrates an example of a composite film.

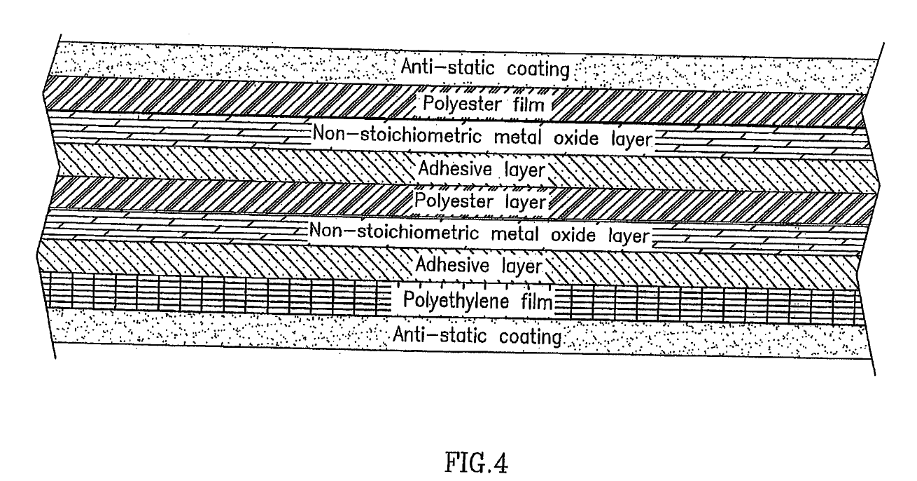

### DETAIL DESCRIPTION OF THE PRESENT INVENTION

The present invention provides a composite film comprising a substrate layer coated on one side with a layer of a non-stoichiometric metal oxide. The present invention further provides a method for producing a composite film comprising depositing a layer of a non-stoichiometric metal oxide on a substrate layer.

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Embodiments of the present invention provide a composite film characterized in semi-transparent shielding with high barrier properties. Embodiments of the present invention relate to construction of metal-based composite films, to methods of their production and to their use. In one embodiment of the present invention, the films are for use in shielding bags but may be used in other applications. In another embodiment, the composite films are used as shielding bags for wrapping an object. In one embodiment of the present invention, the object is a sensitive apparatus namely an apparatus which should be protected against moisture and/or cold and/or heat and/or mechanical damages and/or dust and/or electrostatic discharge. In another embodiment, the apparatus is an electrical apparatus.

In one embodiment, the present invention provides a composite film comprising a multi-layer laminated structure in which a conductive Visible Light Transmission (VLT) non-stoichiometric metal oxide layer is encased by two polymeric plastic layers. An anti-static layer may be further deposited on the inner and outer polymeric layers. The non-stoichiometric metal oxide layer provides electrostatic discharge protection forming a Faraday cage around the bag's contents. The metal layer also controls moisture vapor leakage. In one embodiment of the present invention, a semi-transparent VLT layer of aluminum oxide is used. It will be appreciated that any other layer suitable to transmit visible light and provide electrostatic discharge protection may be used. The semi transparent VLT layer enables bar code reading through the bag, as well as visual inspection and identification of the product. The conductive VLT aluminum oxide layer ensures that electrostatic charges pass around the bag and away from electrostatic discharge sensitive devices. The polymer layers provide strength and act as a sealant to allow the film to be converted into bags. The anti-static coat provides protection against accumulation of electrical charge on the bag surface.

In one embodiment of the invention, the composite film comprises a substrate. In another embodiment the substrate layer is selected from the group consisting of polyethylene terephthalate, polyester, polypropylene, polyvynilydene fluoride and polycarbonate. In another embodiment, the substrate layer is polyethylene terephthalate (“polyester”) film. In one embodiment, the thickness of the substrate layer ranges between 10 and 100 micron. In another embodiment, the thickness of the substrate layer is 12 micron. In another embodiment, the thickness of the substrate layer is 23 micron. In another embodiment the thickness of the substrate layer is 36 micron.

In one embodiment of the present invention, the substrate layer is coated on one side with a layer of a non-stoichiometric metal oxide. In another embodiment, substrate layer further comprising a layer of stoichiometric metal oxide deposited on the layer of a non-stoichiometric metal oxide. In one embodiment of the present invention, the metal is selected from the group consisting of aluminum, titanium, magnesium, cupper, nickel, chromium or zinc. In another embodiment, the metal is aluminum.

In one embodiment of the present invention, the substrate layer is polyester, which is coated with an aluminum oxide layer characterized by a non-stoichiometric ratio between aluminum and oxygen. In one embodiment of the present invention, the aluminum oxide layer is deposited by thermal deposition under vacuum as described in more detail herein below. In another embodiment the aluminum oxide layer may be deposited by sputtering, electron beam, or another physical technique. In order to achieve a semi-transparent layer, the aluminum oxide layer has to be thin but still thick enough to provide an effective anti-static shield. In one embodiment of the present invention, the thickness of the semi transparent layer is between 50 to 1500 Angstrom. In another embodiment, the thickness of the semi-transparent layer is 700 Angstrom.

In one embodiment of the present invention, the composite film further comprising a layer of polymer laminated on the layer of non-stoichiometric metal oxide. In one embodiment of the present invention, the composite film further comprising a layer of polymer laminated on the layer of stoichiometric metal oxide. In one embodiment of the present invention, the laminated polymer layer acts as a sealant, which protects the metal oxide layer and adds thickness and mechanical strength to the composite film. In another embodiment, the laminated polymer layer act as a heat seal layer. In another embodiment, the polymer layers provide strength and act as a sealant to allow the film to be converted into bags. In one embodiment of the present invention, the polymer is selected from the group consisting of linear low density polyethylene, low density polyethylene, medium density polyethylene, high density polyethylene, ethylene vinyl acetate, ethylene vinyl alcohol and polypropylene. In another embodiment the polymer is low density polyethylene. In one embodiment, the thickness of the layer of polymer ranges between 30 and 200 micron.

In one embodiment of the present invention, the composite film further comprising at least an additional layer of substrate laminated between the non-stoichiometric metal oxide coated substrate layer and the polymer layer.

In one embodiment of the present invention, the composite film further comprising at least an additional layer of non-stoichiometric metal oxide coated substrate laminated between the first non-stoichiometric metal oxide coated substrate layer and the polymer layer.

In one embodiment of the present invention, the composite film further comprises an adhesion layer suitable for adhering the polymer layer and the substrate layer. In one embodiment of the present invention, the adhesive layer is an acrylic or a polyurethane adhesive. In another embodiment, the adhesive layer is a polyurethane adhesive. In one embodiment the thickness of the layer of adhesive ranges between 1.5 and 10 micron.

In one embodiment of the present invention, the composite film further comprise at least one layer of anti-static material. In one embodiment of the present invention, the anti-static material is coated on the polymer layer. In another embodiment, the anti-static material is coated on the substrate layer. In another embodiment, the anti-static material is coated on both sides of the composite film. In one embodiment of the present invention, the anti-static property is based on ammonium salts that are wash coated and form a monomolecular layer on top of the polymer layer. The anti-static layer becomes conductive by OH⁻ and H⁺ ion generation. In one embodiment of the preset invention, the thickness of the layer of anti static material ranges between 0.003 and 0.01 micron.

In one embodiment of the present invention, the composite film described above is used as a shielding bag. In another embodiment the shielding bags are used for enclosing sensitive devices. In one embodiment of the present invention, the outer layer of the shielding bag and the inner layer of the shielding bag (e.g. the layer contacts the device) are coated with the anti-static material.

In one embodiment, the present invention provides a method for producing a composite film comprising depositing a layer of non-stoichiometric metal oxide on a substrate layer. In one embodiment, the present invention provides a method further comprising depositing a layer of stoichiometric metal oxide on the layer of non-stoichiometric metal oxide.

In one embodiment of the present invention, the substrate is selected from the group consisting of polyethylene terephthalate, polyester, polypropylene, polyvynilydene fluoride and polycarbonate. In another embodiment, substrate is polyester.

In one embodiment of the present invention, the thickness of the substrate layer ranges between 10 and 100 micron. In another embodiment, the thickness of the substrate layer is 12 micron. In another embodiment, the thickness of the substrate layer is 23 micro. In another embodiment the thickness of the substrate layer is 36 micron.

In one embodiment of the present invention, the layer of metal oxide is deposited on the substrate layer by thermal evaporation, electron beam evaporation or sputtering. In another embodiment, the substrate layer is moving in a selected rate during a selected deposition rate, whereby the thickness of the layer of metal oxide is determined. In another embodiment the thickness of the metal oxide layer is substantially similar in any two selected locations of the composite film. In one embodiment of the present invention, the layer of metal oxide is a non-stoichiometric metal oxide layer. In another embodiment, the layer of metal oxide is a stoichiometric metal oxide layer. In one embodiment of the present invention the thickness of the non-stoichiometric metal oxide layer ranges between 50 and 1500 Angstrom. In one embodiment of the present invention, the thickness of the stoichiometric metal oxide layer ranges between 50 and 3000 Angstrom.

In one embodiment of the present invention, the metal is selected from the group consisting of aluminum, magnesium, cupper, nickel, chromium or zinc. In another embodiment, the metal is aluminum.

In one embodiment of the present invention, the method for producing the composite film is the thermal evaporation method previously applied for producing light sensitive media for the graphic industry and packaging material. In one embodiment of the present invention, the method for producing the aluminum oxide layer may be similar to that disclosed in U.S. Pat. No. 5,693,415 to Applicant. According to a method of the present invention, a web of polyethylene terephthalate film is introduced into a vacuum chamber of a continuous roll coater machine. The chamber is pumped down to obtain high vacuum therein between 10⁻³-10⁻⁵ Torr. Aluminum is then deposited under a controlled flow of oxygen in a continuous fashion on the moving polyethylene terephthalate substrate. The resulting coated layer includes an oxygen deficient aluminum oxide.

In one embodiment of the present invention, the thickness of the non-stoichiometric aluminum oxide layer may be determined in two steps as follows:
A. The desired level of oxygen deficiency is determined by adjusting the oxygen flow; and
B. The thickness of the layer is determined by selecting the deposition rate of the aluminum and the rate in which the substrate web is driven.

In one embodiment of the present invention, the non-stoichiometric aluminum oxide layer is deposited such that its thickness is substantially similar in any two selected locations of the composite film.

In one embodiment, the present invention further provides, the stop of laminating a layer of polymer on the layer of non-stoichiometric metal oxide. In another embodiment, the present invention further provides the step of laminating a layer of polymer on the layer of stoichiometric metal oxide. In one embodiment of the present invention, the polymer is selected from the group consisting of linear low density polyethylene low density polyethylene, medium density polyethylene, high density polyethylene, ethylene vinyl acetate, ethylene vinyl alcohol and polypropylene. In another embodiment, the polymer is low density polyethylene. In one embodiment of the present invention, the thickness of the layer of polymer ranges between 30 and 200 micron.

In one embodiment, the present invention further provides, the step of laminating at least an additional layer of substrate between the non-stoichiometric metal oxide coated substrate layer and the polymer layer.

In one embodiment, the present invention further provides, the step of laminating at least an additional layer of non-stoichiometric metal oxide coated substrate between the first non-stoichiometric metal oxide coated substrate layer and the polymer layer.

In one embodiment the present invention, further comprising the step of coating the layer of polymer with an anti-static material. In one embodiment of the present invention the thickness of the layer of anti static ranges between 0.003 and 0.01 micron.

In one embodiment of the present invention, the polymer and the substrate are laminated using an adhesive layer. In one embodiment of the present invention, the adhesive is an acrylic or a polyurethane adhesive. In another embodiment, the adhesive is a polyurethane adhesive. In one embodiment of the present invention, the thickness of the layer of adhesive ranges between 1.5 and 10 micron.

### EXAMPLES

### Example 1

In one embodiment of the present invention, the composite film comprises the following layers: anti-static wash coat, polyester film, non-stoichiometric aluminum oxide layer, polyurethane adhesive, polyethylene film and anti-static wash coat.

The composite film may vary in its thickness. Typically, the thickness of each layer ranges as follows:

| | | |
|---|---|---|
| polyethylene terephthalate substrate | 10-100 | micron |
| non-stoichiometric aluminum oxide layer | 50-1500 | Angstrom |
| polyurethane adhesive | 1.5-10 | micron |
| polyethylene film | 30-200 | micron |
| anti-static layer | 0.003-0.01 | micron |

It will be appreciate that the properties of the composite film may be controlled by varying the thickness of its layers to achieve the desired transmissivity to light, desired strength, desired color etc.

### Example 2

In one embodiment of the present invention, the composite film comprises the following layers: anti static wash coat, polyethylene terephthalate film, non-stoichiometric aluminum oxide layer, stoichiometric aluminum oxide layer, polyurethane adhesive, polyethylene film and anti static wash coat.

The composite film may vary in its thickness. Typically, the thickness of each layer ranges as follows:

| | | |
|---|---|---|
| polyethylene terephthalate substrate | 10-100 | micron |
| non-stoichiometric aluminum oxide layer | 50-1500 | Angstrom |
| stoichiometric aluminum oxide layer | 50-3000 | Angstrom |
| polyurethane adhesive layer | 1.5-10 | micron |
| Polyethylene film | 30-200 | micron |
| anti static layer | 0.003-0.01 | micron |

It will be appreciated that the properties of the composite film can be controlled by varying the thickness of its layers to achieve the desired properties.

It will be appreciated that the aluminum oxide based layers in composite films having more than one aluminum oxide layer are deposited on their respective substrate by thermal evaporation as described with respect to the first composite film.

### Example 3

Samples of the composite film comprising a first layer of polyethylene terephthalate having a thickness of 12 micron, a second layer of non-stoichiometric aluminum oxide having a thickness of 700 Angstrom, a third layer of stoichiometric aluminum protective, a fourth layer of polyurethane adhesive, a fifth layer of polyethylene sealant having a thickness of 60 micron and a sixth layer of ammonium salt anti-static material having a thickness of 0.007 micron were tested for total visible light transmission, electrostatic shielding, surface resistivity and moisture vapor transmission rate. The results are summarized in Table 1:

TABLE 1

| Test | Result | Units | Test Procedure |
|---|---|---|---|
| Total visible light | 35-40 | % | ASTM D-1003 |
| transmission | | | |
| Electrostatic shielding | <30 | Volts | EIA IS 5A |
| | | | MIL-B-81705C |
| Surface resistivity | <10¹¹ | Ω/□ | ASTM D-257 @ |
| (checked on PET layer) | | | 50% RH (relative |
| | | | humidity) |
| Moisture Vapor H₂O | ≦0.015 | gr/100 in²/day | ASTM F1249-90 |
| Transmission Rate | | 100° F. 100% | |
| (MVTR) | | RH | |
| Surface resistivity | <10¹¹ | Ω/□ | ASTM D-257 @ |
| (checked on LDPE+ | | | 12% RH |
| Anti-static layer) | | | Dr. Thiedig Milli |
| | | | to-2 |

As shown in the Table, a film comprising the described composition has visible light transmission that enables visual recognition, inspection and bar code reading, and have a very low moisture transmission rate.

It will be appreciated that the embodiments described hereinabove are described by way of example only and that numerous modifications thereto, all of which fall within the scope of the present invention, exist. For example, while the present invention is described with respect to a polyethylene terephthalate substrate the composite film may comprise a polyethylene naphthalate film or any other suitable film of the polyester, polyvynilydene fluoride, polypropylene or polycarbonate.

Another example is that while the present invention is described with respect to a polyethylene sealant, the composite films may comprise other sealants such as polypropylene, ethylene vinyl alcohol and ethylene vinyl acetate or any other suitable sealant.

Another example is that while the present invention is described with respect to one aluminum oxide layer, the composite films may comprise more than one aluminum oxide layer separated from the first aluminum oxide layer by a layer of polymer.

In one embodiment of the invention, shielding bags, which are vapor barrier bags, may be manufactured from the composite material described above. The outer layer of the shielding bags comprises the polyester, and the inner layer (e.g. the layer that comes in contact with the product) comprises the polyethylene. Both inner and outer layers are coated with the anti-static material.

In one embodiment, the present invention provides a material comprising a composite film according to the invention. In another embodiment the material is a shielding bag.

In one embodiment, the present invention further provides a use of the composite film for wrapping an object. In one embodiment of the present invention, the composite film is used as a shielding bag for wrapping an object. In one embodiment of the present invention, the object is an electronic apparatus. In another embodiment, the object is an electronic component. In another embodiment, the object is an electrical apparatus. In one embodiment of the present invention, the object is a sensitive apparatus. In another embodiment, the object is any substance which should be protected against moisture and/or cold and/or heat and/or mechanical damages and/or dust and/or electrostatic discharge.

It will be appreciated by persons skilled in the art that the present invention is not limited to what has been particularly shown and described hereinabove. Alternate embodiments are contemplated which fall within the scope of the invention.

1. A composite film comprising a substrate, said substrate has a layer of a non-stoichiometric metal oxide.

2. The composite film according to claim 1, further comprising a layer of a stoichiometric metal oxide on said layer of a non-stoichiometric metal oxide.

3. The composite film according to claim 1, further comprising a layer of polymer laminated on said layer of a non-stoichiometric metal oxide.

4. The composite film according to claim 2, further comprising a layer of polymer laminated on said layer of stoichiometric metal oxide.

5. The composite film according to claim 3, further comprising at least one or more additional layers of a substrate laminated between said non-stoichiometric metal oxide coated substrate layer and said polymer layer.

6. The composite film according to claim 3, further comprising at least one or more additional layers of non-stoichiometric metal oxide coated substrate laminated between said first non-stoichiometric metal oxide coated substrate layer and said polymer layer.

7. The composite film according to claim 1, further comprising an anti-static material coated on said layer of polymer and/or on said layer of substrate.

8. The composite film according to claim 1, wherein the thickness of said substrate layer ranges between 10 and 100 micron.

9. The composite film according to claim 3, wherein the thickness of said layer of polymer ranges between 30 and 200 micron.

10. The composite film according to claim 7 wherein the thickness of said layer of anti static material ranges between 0.003 and 0.01 micron.

11. The composite film according to claim 1, wherein the thickness of said non-stoichiometric metal oxide layer ranges between 50 and 1500 Angstrom.

12. The composite film according to claim 4, wherein the thickness of said stoichiometric metal oxide layer ranges between 50 and 3000 Angstrom.

13. The composite film according to claim 1, wherein said substrate is selected from the group consisting of polyethylene terephthalate, polyester, polypropylene, polyvynilydene fluoride and polycarbonate.

14. The composite film according to claim 13, wherein said substrate is polyester.

15. The composite film according to claim 1, wherein said metal is selected from the group consisting of aluminum, titanium, magnesium, cupper, nickel, chromium or zinc.

16. The composite film according to claim 15, wherein said metal is aluminum.

17. The composite film according to claim 3, wherein said polymer is selected from the group consisting of linear low density polyethylene, low density polyethylene, medium density polyethylene, high density polyethylene, ethylene vinyl acetate, ethylene vinyl alcohol and polypropylene.

18. The composite film according to claim 17, wherein said polymer is low density polyethylene.

19. The composite film according to claim 3, further comprising at least one or more adhesive layers.

20. The method according to claim 19, wherein said adhesive is an acrylic or a polyurethane adhesive.

21. The composite film according to claim 19 wherein the thickness of said layer of adhesive ranges between 1.5 and 10 micron.

22. A method for producing a composite film comprising depositing a layer of a non-stoichiometric metal oxide on a substrate.

23. The method according to claim 22, further comprising depositing a layer of a stoichiometric metal oxide on said layer of a non-stoichiometric metal oxide.

24. The method according to claim 22, further comprising the step of laminating a layer of polymer on said layer of a non-stoichiometric metal oxide.

25. The method according to claim 23, further comprising the step of laminating a layer of polymer on said layer of stoichiometric metal oxide.

26. The method according to claim 24, further comprising the step of laminating at least one or more additional layers of substrate between said non-stoichiometric metal oxide coated substrate layer and said polymer layer.

27. The method according to claim 24, further comprising the step of laminating at least one or more additional layers of non-stoichiometric metal oxide coated substrate between said first non-stoichiometric metal oxide coated substrate layer and said polymer layer.

28. The method according to claim 22, further comprising the step of coating said layer of polymer and/or said layer of substrate with an anti-static material.

29. The method according to claim 22, wherein said layer of metal oxide is deposited on said substrate layer by thermal evaporation, electron beam evaporation or sputtering.

30. The method according to claim 29, wherein said substrate layer is moving in a selected rate during a selected deposition rate, whereby the thickness of said layer of metal oxide is determined.

31. The method according to claim 30, wherein the thickness of said metal oxide layer is substantially similar in any two selected locations of said composite film.

32. The method according to claim 22 wherein the thickness of said substrate layer ranges between 10 and 100 micron.

33. The method according to claim 24 wherein the thickness of said layer of polymer ranges between 30 and 200 micron.

34. The method according to claim 28 wherein the thickness of said layer of anti static material ranges between 0.003 and 0.01 micron.

35. The method according to claim 22, wherein the thickness of said non-stoichiometric metal oxide layer ranges between 50 and 1500 Angstrom.

36. The method according to claim 23, wherein the thickness of said stoichiometric metal oxide layer ranges between 50 and 3000 Angstrom.

37. The method according to claim 22, wherein said substrate is selected from the group consisting of polyethylene terephthalate, polyester, polypropylene, polyvynilydene fluoride and polycarbonate.

38. The method according to claim 37, wherein said substrate is polyester.

39. The method according to claim 22, wherein said metal is selected from the group consisting of aluminum, titanium, magnesium, cupper, nickel, chromium or zinc.

40. The method according to claim 39, wherein said metal is aluminum.

41. The method according to claim 24 wherein said polymer is selected from the group consisting of linear low density polyethylene, low density polyethylene, medium density polyethylene, high density polyethylene, ethylene vinyl acetate, ethylene vinyl alcohol and polypropylene.

42. The method according to claim 41, wherein said polymer is low density polyethylene.

43. The method according to claim 24, said polymer and said substrate are laminated using an adhesive layer.

44. The method according to claim 43, wherein said adhesive is an acrylic or a polyurethane adhesive.

45. The method according to claim 43 wherein the thickness of said layer of adhesive ranges between 1.5 and 10 micron.

46. A material comprising a composite film according to claim 1.

47. Use of a composite film according to claim 1 for wrapping an object.
